(19) United States
(12) Patent Application Publication
(10) Pub. No.: US 2024/0117155 A1
(43) Pub. Date: Apr. 11, 2024

(54) MANUFACTURING METHOD AND MOLDED ARTICLE OF HEAT-RESISTANT TABLEWARE

(71) Applicant: NAN YA PLASTICS CORPORATION, TAIPEI (TW)

(72) Inventors: TE-CHAO LIAO, TAIPEI (TW); HAN-CHING HSU, TAIPEI (TW); CHUN-LAI CHEN, TAIPEI (TW)

(21) Appl. No.: 18/071,569

(22) Filed: Nov. 29, 2022

(30) Foreign Application Priority Data
Oct. 7, 2022 (TW) 111138132

(51) Int. Cl. C08K 13/02; C08G 63/183; C08L 67/02

(52) U.S. Cl. CPC C08K 13/02; C08G 63/183; C08L 67/02

(57) ABSTRACT

A manufacturing method of a heat-resistant tableware and a molded article of the heat-resistant tableware are provided. The manufacturing method of the heat-resistant tableware includes: providing a polyester composite material that includes 50 wt % to 85 wt % of polyethylene terephthalate, 0 wt % to 5 wt % of an organic nucleating agent, and 10 wt % to 30 wt % of an inorganic nucleating agent; and injecting the polyester composite material into a mold in an injection molding process, in which a mold temperature of the mold is controlled to be not less than 110° C., and a crystallinity of the polyester composite material in the mold is controlled to be between 20% and 30%, so that the polyester composite material is formed into the molded article of the heat-resistant tableware in the mold, and the molded article has a heat distortion temperature of not less than 150° C.

### CROSS-REFERENCE TO RELATED PATENT APPLICATION

This application claims the benefit of priority to Taiwan Patent Application No. 111138132, filed on Oct. 7, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a manufacturing method of tableware, and more particularly to a manufacturing method of a heat-resistant tableware and a molded article of the heat-resistant tableware.

### BACKGROUND OF THE DISCLOSURE

Melamine tableware is a type of tableware made from a melamine-formaldehyde resin. However, the melamine tableware can release a toxic substance, melamine, at about 40° C., thus raising a food safety issue and endangering human health.

Polyethylene terephthalate (PET) is a non-toxic plastic, which can withstand a temperature of up to 140° C. in use, and has been widely used in containers for water or beverages. Taiwan Patent No. TWI711668B, provides a use of a low density PET composite material. Such a composite material includes PET in combination with polybutylene terephthalate (PBT), and is suitable to be adapted in an injection molding process for making tableware that is aesthetically pleasing and safe for being used in food consumption.

However, a tableware produced by adapting the aforementioned patent has a low heat distortion temperature, and in the specifications of the aforementioned patent, the examples 1 to 4 as shown in Table 1 show that the heat distortion temperatures of the tableware are all less than 100° C. To increase the heat distortion temperature of the tableware, the tableware needs to be reprocessed so that the heat distortion temperature can be greater than 100° C. Furthermore, a content of an inorganic filler used in this patent is 10 wt % at most. Therefore, the tableware has a ceramic luster, but does not have a thick texture of a ceramic. Moreover, excessive addition of inorganic filler may result in insufficient mechanical strength of the tableware.

### SUMMARY OF THE DISCLOSURE

In response to the above-referenced technical inadequacies, the present disclosure provides a manufacturing method of a heat-resistant tableware and a molded article of the heat-resistant tableware to address the issue that a heat distortion temperature of a tableware is insufficient.

In one aspect, the present disclosure provides a manufacturing method of a heat-resistant tableware. The manufacturing method of the heat-resistant tableware includes: providing a polyester composite material, in which based on a total weight of the polyester composite material being 100 wt %, the polyester composite material contains 50 wt % to 85 wt % of PET, 0 wt % to 5 wt % of an organic nucleating agent, and 10 wt % to 30 wt % of an inorganic nucleating agent; and injecting the polyester composite material into a mold in an injection molding process, in which a mold temperature of the mold is controlled to be not less than 110° C., and a crystallinity of the polyester composite material in the mold is controlled to be between 20% and 40%, so that the polyester composite material is formed into a molded article of the heat-resistant tableware in the mold, the molded article of the heat-resistant tableware having a heat distortion temperature of not less than 150° C.

In certain embodiments, the polyester composite material does not contain PBT.

In certain embodiments, the organic nucleating agent is at least one material selected from a group consisting of an ionic polymer, an alkali metal salt of a polyester oligomer, a long-chain linear saturated carboxylic acid sodium salt, a long-chain linear saturated carboxylic acid calcium salt, a long-chain linear saturated aromatic carboxylic acid metal sodium salt, and a long-chain linear saturated aromatic carboxylic acid metal magnesium salt.

In certain embodiments, the inorganic nucleating agent is at least one material selected from a group consisting of talc, barium sulfate, calcium carbonate, and calcium silicate, in which the inorganic nucleating agent has an average particle size ranging from 0.1 μm to 5 μm.

In certain embodiments, the polyester composite material is formed into the molded article of the heat-resistant tableware having the heat distortion temperature of not less than 150° C. through a single heat treatment in the mold.

In certain embodiments, after the polyester composite material is formed into the molded article of the heat-resistant tableware in the mold, the manufacturing method further includes: removing the molded article of the heat-resistant tableware from the mold, in which at least 95 wt % of the composite material of the molded article of the heat-resistant tableware does not stick to or remain in the mold.

In certain embodiments, the polyester composite material further contains 0.1 wt % to 0.5 wt % of an antioxidant and 0.1 wt % to 1.0 wt % of a processing aid.

In certain embodiments, the antioxidant is at least one material selected from a group consisting of tetrakis (3,5-di-tert-butyl-4-hydroxy) pentaerythritol phenylpropionate, tris (2,4-di-tert-butyl) phenyl phosphite, and 3-(3,5-di-tert-butyl-4-hydroxyphenyl) octadecyl propionate.

In certain embodiments, the processing aid is at least one material selected from a group consisting of ethylene bis-stearylamide (EBS), erucamide, polyethylene wax, paraffin wax, stearic acid, zinc stearate, calcium stearate, and polydimethylsiloxane.

In another aspect, the present disclosure provides a molded article of a heat-resistant tableware, which is formed by the manufacturing method of a heat-resistant tableware described above, in which the molded article of the heat-resistant tableware has a crystallinity ranging from 20% to 40% and a heat distortion temperature of not less than 150° C.

The present disclosure has the following beneficial effects. A main feature of the manufacturing method of a heat-resistant tableware in the present disclosure is that, the amount of the inorganic nucleating agent used is increased to be from 10 wt % to 30 wt % (preferably from 15 wt % to 20 wt %). Therefore, when PET resin is used and no PBT resin is used, by injection molding at a high mold temperature (e.g., a mold temperature of not less than 110° C.) in combination with controlling the crystallinity of the polyester composite material, the molded article of the heat-resistant tableware that is finally formed can have a high heat distortion temperature (e.g., not less than 150° C.) through a single heat treatment in the mold with the mold temperature.

Further, compared to the prior art (Taiwan Patent No. TWI711668B), the manufacturing method of the heat-resistant tableware of the present disclosure increases the amount of the inorganic nucleating agent used, which can accelerate the crystallization rate of the PET resin, thereby substituting the effect of the PBT formula in the prior art. In addition, the manufacturing method of the heat-resistant tableware in embodiments of the present disclosure can facilitate molding of the polyester composite material without sticking to the mold at a high mold temperature. Because an appropriate increase in the amount of the inorganic nucleating agent used can appropriately reduce the amount of the PET resin used, the problem that the PET resin sticks to or remains in the mold is addressed. That is, after being formed at the foregoing mold temperature, the molded article of the heat-resistant tableware is unlikely to stick to or remain in the mold, and can be completely removed from the mold. Also, the high mold temperature improves the crystallinity of the molded article of the heat-resistant tableware. Therefore, the finally formed molded article of the heat-resistant tableware can have a high heat distortion temperature (e.g., not less than 150° C.) and hardness through a single heat treatment in the mold with the mold temperature.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic flowchart of a manufacturing method of a heat-resistant tableware in one embodiment of the present disclosure.

### DETAILED DESCRIPTION OF THE EXEMPLARY EXAMPLES

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Manufacturing Method of a Heat-Resistant Tableware

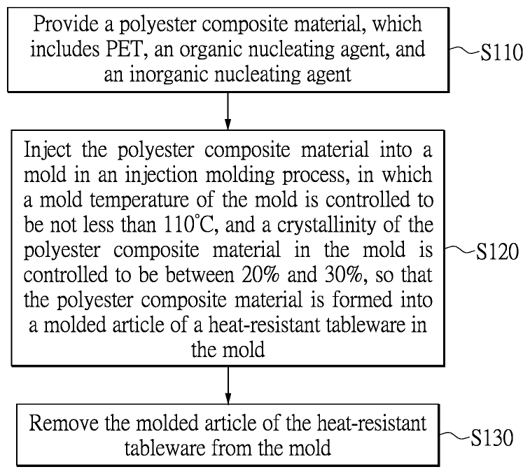

Referring to FIG. 1, one embodiment of the present disclosure provides a manufacturing method of a heat-resistant tableware, and the manufacturing method includes steps S110, S120, and S130.

Step S110 includes: providing a polyester composite material that includes polyethylene terephthalate (PET), an organic nucleating agent, and an inorganic nucleating agent.

Based on a total weight of the polyester composite material being 100 wt %, the content of PET ranges from 50 wt % to 85 wt %, the content of the organic nucleating agent ranges from 0 wt % to 5 wt %, and the content of the inorganic nucleating agent ranges from 10 wt % to 30 wt %. In one preferred embodiment of the present disclosure, the content of PET ranges from 75 wt % to 85 wt %, the content of the organic nucleating agent ranges from 0 wt % to 3 wt %, and the content of the inorganic nucleating agent ranges from 15 wt % to 20 wt %. However, the present disclosure is not limited thereto.

In one preferred embodiment of the present disclosure, the polyester composite material does not contain polybutylene terephthalate (PBT), but the present disclosure is not limited thereto.

With respect to the material type, the PET has a relative density ranging from 1.35 g/cm³ to 1.40 g/cm³, a melting point ranging from 245° C. to 260° C., and an intrinsic viscosity (IV) ranging from 0.65 dL/g to 1.01 dL/g.

The organic nucleating agent is at least one material selected from a group consisting of an ionic polymer, an alkali metal salt of a polyester oligomer, a long-chain linear saturated carboxylic acid sodium salt, a long-chain linear saturated carboxylic acid calcium salt, a long-chain linear saturated aromatic carboxylic acid metal sodium salt, and a long-chain linear saturated aromatic carboxylic acid metal magnesium salt.

The inorganic nucleating agent is at least one material selected from a group consisting of talc, barium sulfate, calcium carbonate, and calcium silicate. In one preferred embodiment of the present disclosure, the inorganic nucleating agent has an average particle size ranging from 0.1 lam to 5 μm. In a more preferred embodiment of the present disclosure, the inorganic nucleating agent has an average particle size ranging from 1 μm to 3 μm, but the present disclosure is not limited thereto.

In one preferred embodiment of the present disclosure, the polyester composite material further contains 0.1 wt % to 0.5 wt % of an antioxidant and 0.1 wt % to 1.0 wt % of a processing aid.

The antioxidant is at least one material selected from a group consisting of tetrakis (3,5-di-tert-butyl-4-hydroxy) pentaerythritol phenylpropionate, tris (2,4-di-tert-butyl) phenyl phosphite, and 3-(3,5-di-tert-butyl-4-hydroxyphenyl) octadecyl propionate.

The processing aid is at least one material selected from a group consisting of ethylene bis-stearylamide (EBS), erucamide, polyethylene wax, paraffin wax, stearic acid, zinc stearate, calcium stearate, and polydimethylsiloxane.

Step S120 includes: injecting the polyester composite material into a mold in an injection molding process, in which a mold temperature of the mold is controlled to be not less than 110° C. (preferably from 110° C. to 140° C.), and a crystallinity of the polyester composite material in the mold is controlled to be between 20% and 40% (preferably between 25% and 40%), so that the polyester composite material is formed into a molded article of a heat-resistant tableware in the mold. According to the foregoing manufacturing method, the molded article of the heat-resistant tableware can have a heat distortion temperature of not less than 150° C.

In one preferred embodiment of the present disclosure, the polyester composite material is passed through a twin screw extruder for mixing of different materials and then extruded and pelletized. Afterwards, the polyester composite material that is pelletized is injected into the mold in the injection molding process, so as to form the molded article of the heat-resistant tableware.

It should be noted that, the polyester composite material is formed into the molded article of the heat-resistant tableware having a heat distortion temperature of not less than 150° C. through a single heat treatment in the mold. That is to say, the molded article of the heat-resistant tableware can have a desired heat distortion temperature by means of a single heat treatment without the need for a second heat treatment.

Step S130 includes: removing the molded article of the heat-resistant tableware from the mold. It should be noted that, according to the technical solution provided by the embodiments of the present disclosure, at least 95 wt % of the composite material of the molded article of the heat-resistant tableware does not stick to or remain in the mold. That is to say, in general, the molded article of the heat-resistant tableware can be completely removed from the mold.

According to the technical solution provided by the embodiments of the present disclosure, the embodiments of the present disclosure have the following technical effects.

According to the manufacturing method of heat-resistant tableware in the embodiment of the present disclosure, by adjusting a formula of the polyester composite material and controlling a mold temperature and a crystallinity of the polyester composite material, the molded article of the heat-resistant tableware that is finally formed has a high heat distortion temperature.

In terms of the formula, the polyester composite material uses PET as the matrix material of the heat-resistant tableware, and an inorganic nucleating agent is added to the polyester composite material and an organic nucleating agent is optionally added to the polyester composite material.

More specifically, a main feature of the manufacturing method of the heat-resistant tableware in the embodiment of the present disclosure is that, the amount of the inorganic nucleating agent used is increased to be from 10 wt % to 30 wt % (preferably from 15 wt % to 20 wt %). Therefore, when PET resin is used and no PBT resin is used, by injection molding at a high mold temperature (e.g., a mold temperature of not less than 110° C.) in combination with controlling the crystallinity of the polyester composite material, the molded article of the heat-resistant tableware that is finally formed can have a high heat distortion temperature (e.g., not less than 150° C.) through a single heat treatment in the mold with the mold temperature.

Furthermore, compared to the prior art (Taiwan Patent No. TWI711668B), the manufacturing method of the heat-resistant tableware of the present disclosure increases the amount of the inorganic nucleating agent used, which can accelerate the crystallization rate of the PET resin, thereby substituting the effect of the PBT formula in the prior art. In addition, the manufacturing method of the heat-resistant tableware in embodiments of the present disclosure can facilitate molding of the polyester composite material without sticking to the mold at a high mold temperature. Because an appropriate increase in the amount of the inorganic nucleating agent used can appropriately reduce the amount of the PET resin used, the problem that the PET resin sticks to or remains in the mold is addressed. That is to say, after being formed at the foregoing mold temperature, the molded article of the heat-resistant tableware is unlikely to stick to or remain in the mold, and can be completely removed from the mold. Also, the high mold temperature improves the crystallinity of the molded article of the heat-resistant tableware. Therefore, the finally formed molded article of the heat-resistant tableware can have a high heat distortion temperature (e.g., not less than 150° C.) and hardness through a single heat treatment in the mold with the mold temperature.

In the manufacturing method of the heat-resistant tableware in the embodiment of the present disclosure, the molded article of the heat-resistant tableware can have a desired hardness and heat distortion temperature only by controlling the crystallinity of the polyester composite material in the mold to be between 20% and 40%.

It should be noted that, the crystallinity of the polyester composite material mentioned in the present disclosure refers to a proportion of the crystalline part in the polymer to the polymer, and can be referred to in the following formula: the crystallinity=the crystalline part/(the crystalline part+the non-crystalline part). The analysis method of the crystallinity may involve using differential scanning calorimetry (DSC). The DSC analysis conditions in the embodiment of the present disclosure include a temperature increase (the temperature is increased from 0° C. to 300° C. at a rate of 20° C./min), followed by a temperature decrease (the temperature is decreased from 300° C. to 0° C. at a rate of 20° C./min) Before the injection molding process, the polyester composite material in the embodiments of the present disclosure needs to have the following crystallization parameter values in the DSC test: a crystal peak temperature ranging from 190° C. to 220° C., a supercooling degree ΔTc ranging from 30° C. to 42° C., and a half-peak breadth of crystal temperature that ranges from 190° C. to 220° C., so as to be suitable for molding at a high mold temperature.

It should be noted that, in the prior art (Taiwan Patent No. TWI711668B), a manufacturing method of the heat-resistant tableware does not provide and also does not describe technical contents that can provide “controlling the mold temperature of the mold to be not less than 110° C.”. In the prior art, when the formula using PET in combination with PBT in the prior art is heated at a mold temperature of higher than 80° C. or above, the PET and PBT resin materials easily stick to the mold, such that it is difficult to remove the molded tableware from the mold.

In the polyester composite material, the content of the inorganic nucleating agent is required to range from 10 wt % to 30 wt % (preferably from 15 wt % to 20 wt %), thereby achieving an effect of facilitating acceleration of the crystallization rate of the PET resin.

If the content of the inorganic nucleating agent is lower than a lower limit value (for example, less than 10 wt %) of the foregoing content range, the inorganic nucleating agent cannot effectively facilitate acceleration of the crystallization rate of the PET resin, and also cannot enable the polyester composite material to be injection-molded at a high mold temperature under the condition of using only PET resin without PBT resin. If the content of the inorganic nucleating agent is higher than an upper limit value (for example, higher than 30 wt %) of the foregoing content range, the molding effect and physical properties of the molded article of the heat-resistant tableware may be affected due to the excessively high content of the inorganic material.

In addition, the particle size of the inorganic nucleating agent is required to range from 0.1 lam to 5 μm (preferably from 1 μm to 3 μm). The inorganic nucleating agent in the foregoing particle size range will facilitate acceleration of the crystallization rate of the PET resin.

In the polyester composite material, the organic nucleating agent is required to range from 0 wt % to 5 wt % (preferably from 0 wt % to 3 wt %). That is to say, the organic nucleating agent may be optionally added or not added, and even if the organic nucleating agent is added, a content of the organic nucleating agent should not exceed 5 wt %. The crystallinity of the polyester composite material in the mold may increase as the content of the organic nucleating agent increases. However, if the amount of the organic nucleating agent exceeds 5 wt % or more, the improvement of the crystallinity of the polyester composite material will not be apparent.

Therefore, in the manufacturing method of the heat-resistant tableware in the embodiment of the present disclosure, when 10 wt % to 30 wt % of an inorganic nucleating agent (such as talc, barium sulfate, calcium carbonate, and calcium silicate) is introduced into the PET resin and the crystallinity is controlled, the mechanical properties, such as the notched impact strength, tensile strength, flexural strength, etc., of the molded article of the heat-resistant tableware do not deteriorate; furthermore, the processing fluidity and injection moldability of the resin material can be improved. By adjustment of the conditions of the injection molding process, the molded article of the heat-resistant tableware can have a high heat distortion temperature, and can be used as a heat-resistant tableware applicable to microwaves and high-temperature steaming.

The polyester composite material in the embodiments of the present disclosure is suitable for being processed by injection molding and requires only one processing step. The heat distortion temperature of the molded article of the heat-resistant tableware can be higher than 150° C., and the molded article of the heat-resistant tableware does not need to undergo a second heat treatment, thereby greatly shortening the processing time. In addition, a polymer material used in the molded article of the heat-resistant tableware in the embodiments of the present disclosure may all be PET resin, which is helpful for recycle and reuse afterwards.

### Experiment Test

The content of the present disclosure is described in detail below with reference to Examples 1 and 2, and Comparative Examples 1 to 3. However, the following examples are only made to assist in understanding the present disclosure, and the scope of the present disclosure is not limited to these examples.

Example 1: a tableware molded article is manufactured according to the formula of the polyester composite material in Table 1, in which the polyester composite material contains 84.3 wt % of PET, 15 wt % of talc (an inorganic nucleating agent), 0.15 wt % of an antioxidant (a ratio of tetrakis (3,5-di-tert-butyl-4-hydroxy) pentaerythritol phenylpropionate to tris (2,4-di-tert-butyl) phenyl phosphite used in Example 1 is 1:1), and 0.4 wt % of a processing aid (polyethylene wax used in Example 1). The polyester composite material does not contain PBT and an organic nucleating agent. The formulated polyester composite material is extruded, pelletized, and dried by a twin screw extruder. The tableware molded article is then manufactured in an injection molding process in which the mold temperature for injection molding is controlled to be 110° C., and the crystallinity of the polyester composite material in the mold is controlled to be from 20% to 40%. The physical properties of the manufactured tableware are tested at room temperature, and the test results are as shown in Table 1.

Example 2: a tableware molded article is manufactured according to the formula of the polyester composite material in Table 1, in which the polyester composite material contains 78.3 wt % of PET, 15 wt % of barium sulfate (an inorganic nucleating agent), 3 wt % of talc (an inorganic nucleating agent), 1.15 wt % of an organic nucleating agent (an ionic polymer used in example 2), 0.15 wt % of an antioxidant (a ratio of tetrakis (3,5-di-tert-butyl-4-hydroxy) pentaerythritol phenylpropionate to tris (2,4-di-tert-butyl) phenyl phosphite used in Example 2 is 1:1), 0.4 wt % of a processing aid (polyethylene wax used in Example 2), and 2 wt % of a toughener (a terpolymer of ethylene, methyl acrylate, and glycidyl enoate used in Example 2). The polyester composite material does not contain PBT. The formulated polyester composite material is extruded, pelletized, and dried by a twin screw extruder. The tableware molded article is then manufactured in an injection molding process in which the mold temperature for injection molding is controlled to be 110° C. and the crystallinity of the polyester composite material in the mold is controlled to be from 20% to 40%. The physical properties of the manufactured tableware are tested at room temperature, and the test results are as shown in Table 1.

Comparative Example 1: a tableware molded article is manufactured according to the formula of the polyester composite material in Table 1, in which the polyester composite material contains 83.6 wt % of PET, 10 wt % of PBT, 6 wt % of barium sulfate, and 0.4 wt % of an antioxidant (a ratio of tetrakis (3,5-di-tert-butyl-4-hydroxy) pentaerythritol phenylpropionate to tris (2,4-di-tert-butyl) phenyl phosphite used in Comparative Example 1 is 1:1). The formulated polyester composite material is extruded, pelletized, and dried by a twin screw extruder. The tableware molded article is then manufactured in an injection molding process in which the mold temperature for injection molding is controlled to be 70° C. The physical properties of the manufactured tableware are tested at room temperature, and the test results are as shown in Table 1.

Comparative Example 2: a tableware molded article is manufactured according to the formula of the polyester composite material in Table 1, in which the polyester composite material contains 81.3 wt % of PET, 10 wt % of PBT, 6 wt % of talc, 1.5 wt % of an organic nucleating agent (an ionic polymer used in the comparative example 2), 0.4 wt % of an antioxidant (a ratio of tetrakis (3,5-di-tert-butyl-4-hydroxy) pentaerythritol phenylpropionate to tris (2,4-di-tert-butyl) phenyl phosphite used in Comparative Example 2 is 1:1), and 0.8 wt % of a processing aid (polyethylene wax used in Comparative Example 2). The formulated polyester composite material is extruded, pelletized, and dried by a twin screw extruder. The tableware molded article is then manufactured in an injection molding process in which the mold temperature for injection molding is controlled to be 70° C. The physical properties of the manufactured tableware are tested at room temperature, and the test results are as shown in Table 1.

Comparative Example 3: a tableware molded article is manufactured according to the formula of the polyester composite material in Table 1, in which the polyester composite material contains 98.3 wt % of PET, 1.15 wt % of an organic nucleating agent (an ionic polymer used in Comparative Example 3), 0.15 wt % of an antioxidant (a ratio of tetrakis (3,5-di-tert-butyl-4-hydroxy) pentaerythritol phenylpropionate to tris (2,4-di-tert-butyl) phenyl phosphite used in Comparative Example 3 is 1:1), and 0.4 wt % of a processing aid (polyethylene wax used in Comparative Example 3). The formulated polyester composite material is extruded, pelletized, and dried by a twin screw extruder. The tableware molded article is then manufactured in an injection molding process in which the mold temperature for injection molding is controlled to be 50° C. The physical properties of the manufactured tableware are tested at room temperature, and the test results are as shown in Table 1.

For the physical properties of the tableware, such as the notched impact strength (KJ/m 2), tensile strength (MPa), flexural strength (MPa), flexural modulus (MPa), heat distortion temperature (° C.), injection moldability, and surface gloss, the related test methods are as follows.

The notched (Izod) impact strength (kg-cm/cm) is tested according to ASTM D 256. The sample dimensions (mm) are (63.5±2)×(12.7±0.2)×(3.2±0.2), the notch angle is 45±1°, the radius is 0.25±0.12 mm, and the notch depth is 10.16±0.05 mm.

The tensile strength (MPa) is measured according to ASTM D 638. The sample dimensions (mm) are (165±2)×(19±0.2)×(3.2±0.2), and the tensile speed is 50 mm/min.

The flexural strength (MPa) is measured according to ASTM D 790. The sample dimensions (mm) are (127±2)×(12.7±0.2)×(3.2±0.2), and the bending rate is 13 mm/min.

The flexural modulus (MPa) is measured according to ASTM D 790. The sample dimensions (mm) are (127±2)×(12.7±0.2)×(3.2±0.2) and the bending rate is 13 mm/min.

The heat distortion temperature is measured according to ASTM D648. The sample dimensions (mm) are (127±2)×(12.7±0.2)×(3.2±0.2), the heating rate is 120° C./hr, the pressure is 1.82 MPa (4.6 kg/cm²), and the deformation is set to be 0.254 mm

TABLE 1

| | | | | | Comparative | Comparative | Comparative |
|---|---|---|---|---|---|---|---|
| | Composition (wt %) | | Example 1 | Example 2 | Example 1 | Example 2 | Example 3 |
| Formula and | PET | | 84.3 | 78.3 | 83.6 | 81.3 | 98.3 |
| process | PBT | | — | — | 10 | 10 | — |
| conditions | Inorganic | Barium | — | 15 | 6 | — | — |
| of the | nucleating | sulfate | | | | | |
| polyester | agent | Talc | 15 | 3 | — | 6 | — |

| | | | | | | |
|---|---|---|---|---|---|---|
| composite | Organic | — | 1.15 | — | 1.5 | 1.15 |
| material | nucleating agent | | | | | |
| | Antioxidant | 0.15 | 0.15 | 0.4 | 0.4 | 0.15 |
| | Processing aid | 0.4 | 0.4 | — | 0.8 | 0.4 |
| | Toughener | — | 2 | — | — | — |
| | Mold temperature | 110 | 110 | 70 | 70 | 50 |
| | (° C.) | | | | | |
| | Crystallinity (%) | 33.28 | 36.35 | 14.35 | 18.78 | 14.29 |
| | measured by | | | | | |
| | DSC | | | | | |
| Physical | Notched impact | 3.75 | 3.8 | 3.9 | 3.7 | 3.7 |
| properties | strength (KJ/m²) | | | | | |
| of the | Tensile strength | 60.7 | 61.9 | 55.1 | 49.4 | 60.2 |
| tableware | (MPa) | | | | | |
| molded | Flexural strength | 87.4 | 88.3 | 87.2 | 86.6 | 85.5 |
| article | (MPa) | | | | | |
| | Flexural modulus | 3,760 | 3,290 | 2,608 | 2,834 | 2,550 |
| | (MPa) | | | | | |
| | Heat distortion | 180 | 203 | 79 | 92 | 78 |
| | temperature (° C.) | | | | | |
| | Injection | Qualified | Qualified | Poor | Qualified | Qualified |
| | moldability | | | | | |
| | Surface gloss | Qualified | Qualified | Poor | Qualified | Qualified |

### Discussion of Test Results

In Examples 1 and 2, a high content of the inorganic nucleating agent (from 15 wt % to 20 wt %) is used in the formula of the polyester composite material. In Examples 1 and 2, the tableware molded article is manufactured in an injection molding process in which the mold temperature for injection molding is controlled to be at 110° C. Compared to the Comparative Examples 1 to 3, the tableware molded articles in Examples 1 and 2 have superior heat distortion temperature (not less than 150° C.) and flexural modulus (not less than 3,000). Furthermore, in terms of the physical properties such as the notched impact strength, tensile strength (MPa), flexural strength (MPa), etc, the tableware molded articles in Examples 1 and 2 perform better than the tableware molded articles in the Comparative Examples 1 to 3. In addition, the tableware molded articles in Examples 1 and 2 both meet qualification standards in terms of quality inspection for the injection moldability and surface gloss.

Because a high content of inorganic nucleating agent is not used in the Comparative Examples 1 to 3 (a content of inorganic nucleating agent is less than 10 wt %), the mold temperature for injection molding in the Comparative Examples 1 to 3 cannot be too high (cannot be higher than 80° C.); otherwise, the tableware molded article that is produced is likely to stick to the mold and is not easily released. In addition, in terms of the heat distortion temperature and the flexural modulus, the tableware molded articles in the Comparative Examples 1 to 3 perform poorer than the tableware molded articles in Examples 1 and 2.

### Beneficial Effects of the Embodiments

A main feature of the manufacturing method of the heat-resistant tableware in an embodiment of the present disclosure is that, the amount of the inorganic nucleating agent used is increased to be from 10 wt % to 30 wt % (preferably from 15 wt % to 20 wt %). Therefore, when PET resin is used and no PBT resin is used, by injection molding at a high mold temperature (e.g., a mold temperature of not less than 110° C.) in combination with controlling the crystallinity of the polyester composite material, the molded article of the heat-resistant tableware that is finally formed can have a high heat distortion temperature (e.g., not less than 150° C.) through a single heat treatment in the mold with the mold temperature.

Further, compared to the prior art (Taiwan Patent No. TWI711668B), the manufacturing method of the heat-resistant tableware of the present disclosure increases the amount of the inorganic nucleating agent used, which can accelerate the crystallization rate of the PET resin, thereby substituting the effect of the PBT formula in the prior art. In addition, the manufacturing method of the heat-resistant tableware in embodiments of the present disclosure can facilitate molding of the polyester composite material without sticking to the mold at a high mold temperature. Because an appropriate increase in the amount of the inorganic nucleating agent used can appropriately reduce the amount of the PET resin used, the problem that the PET resin sticks to or remains in the mold is addressed. That is, after being formed at the foregoing mold temperature, the molded article of the heat-resistant tableware is unlikely to stick to or remain in the mold, and can be completely removed from the mold. Also, the high mold temperature improves the crystallinity of the molded article of the heat-resistant tableware. Therefore, the finally formed molded article of the heat-resistant tableware can have a high heat distortion temperature (e.g., not less than 150° C.) and hardness through a single heat treatment in the mold with the mold temperature.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A manufacturing method of a heat-resistant tableware, comprising:
providing a polyester composite material, wherein based on a total weight of the polyester composite material being 100 wt %, the polyester composite material contains 50 wt % to 85 wt % of polyethylene terephthalate (PET), 0 wt % to 5 wt % of an organic nucleating agent, and 10 wt % to 30 wt % of an inorganic nucleating agent; and
injecting the polyester composite material into a mold in an injection molding process, wherein a mold temperature of the mold is controlled to be not less than 110° C., and a crystallinity of the polyester composite material in the mold is controlled to be between 20% and 30%, so that the polyester composite material is formed into a molded article of the heat-resistant tableware in the mold, wherein the molded article of the heat-resistant tableware has a heat distortion temperature of not less than 150° C.

2. The manufacturing method according to claim 1, wherein the polyester composite material does not contain polybutylene terephthalate (PBT).

3. The manufacturing method according to claim 1, wherein the organic nucleating agent is at least one material selected from a group consisting of an ionic polymer, an alkali metal salt of a polyester oligomer, a long-chain linear saturated carboxylic acid sodium salt, a long-chain linear saturated carboxylic acid calcium salt, a long-chain linear saturated aromatic carboxylic acid metal sodium salt, and a long-chain linear saturated aromatic carboxylic acid metal magnesium salt.

4. The manufacturing method according to claim 1, wherein the inorganic nucleating agent is at least one material selected from a group consisting of talc, barium sulfate, calcium carbonate, and calcium silicate, and wherein the inorganic nucleating agent has an average particle size ranging from 0.1 μm to 5 μm.

5. The manufacturing method according to claim 1, wherein the polyester composite material is formed into the molded article of the heat-resistant tableware having the heat distortion temperature of not less than 150° C. through a single heat treatment in the mold.

6. The manufacturing method according to claim 1, wherein, after the polyester composite material is formed into the molded article of the heat-resistant tableware in the mold, the manufacturing method further comprises: removing the molded article of the heat-resistant tableware from the mold, wherein at least 95 wt % of the composite material of the molded article of the heat-resistant tableware does not stick to or remain in the mold.

7. The manufacturing method according to claim 1, wherein the polyester composite material further contains 0.1 wt % to 0.5 wt % of an antioxidant and 0.1 wt % to 1.0 wt % of a processing aid.

8. The manufacturing method according to claim 7, wherein the antioxidant is at least one material selected from a group consisting of tetrakis (3,5-di-tert-butyl-4-hydroxy) pentaerythritol phenylpropionate, tris (2,4-di-tert-butyl) phenyl phosphite, and 3-(3,5-di-tert-butyl-4-hydroxyphenyl) octadecyl propionate.

9. The manufacturing method according to claim 7, wherein the processing aid is at least one material selected from a group consisting of ethylene bis-stearylamide (EBS), erucamide, polyethylene wax, paraffin wax, stearic acid, zinc stearate, calcium stearate, and polydimethylsiloxane.

10. A molded article of a heat-resistant tableware formed by the manufacturing method of a heat-resistant tableware according to claim 1, wherein the molded article of the heat-resistant tableware has a crystallinity ranging from 20% to 30% and a heat distortion temperature of not less than 150° C.
